(19) United States
(12) Patent Application Publication
(10) Pub. No.: US 2026/0213072 A1
(43) Pub. Date: Jul. 23, 2026

(54) MULTILAYER ELECTRONIC COMPONENT

(71) Applicant: SAMSUNG ELECTRO-MECHANICS CO., LTD., Suwon-si (KR)

(72) Inventor: Beom Joon Cho, Suwon-si (KR)

(73) Assignee: SAMSUNG ELECTRO-MECHANICS CO., LTD., Suwon-si (KR)

(21) Appl. No.: 19/393,418

(22) Filed: Nov. 18, 2025

(30) Foreign Application Priority Data
Jan. 23, 2025 (KR) 10-2025-0010244

(51) Int. Cl. H01G 4/224; C04B 35/64; H01G 4/008; H01G 4/012; H01G 4/12; H01G 4/30

(52) U.S. Cl. CPC H01G 4/224; C04B 35/64; H01G 4/008; H01G 4/012; H01G 4/12; H01G 4/30

(57) ABSTRACT

A multilayer electronic component comprises a body with a capacitance formation portion having dielectric layers and internal electrodes alternately stacked in a first direction. Cover portions containing dielectric grains are positioned on the upper and lower surfaces of the capacitance formation portion, while external electrodes are arranged on opposite sides of the body in a second direction, perpendicular to the first. Each cover portion includes an inner cover adjacent to the capacitance formation portion and an outer cover on the outside. In a cross-section along the first and second directions, LSo represents the ratio of the sum of major to minor axis lengths of dielectric grains in the outer cover, and LSi represents the same ratio for the inner cover, satisfying LSi<LSo. The outer cover includes first dielectric grains with a major-to-minor axis ratio between 3 and 30.

### CROSS-REFERENCE TO RELATED APPLICATION(S)

This application claims benefit of priority to Korean Patent Application No. 10-2025-0010244 filed on Jan. 23, 2025 in the Korean Intellectual Property Office, the disclosure of which is incorporated herein by reference in its entirety.

### TECHNICAL FIELD

The present disclosure relates to a a multilayer electronic component.

### BACKGROUND

A multilayer ceramic capacitor (MLCC) is a type of multilayer electronic component that is commonly used as a chip-type capacitor in modern electronic circuits. MLCCs are typically mounted on printed circuit boards (PCBs) of various electronic products, including image display devices such as liquid crystal displays (LCDs) and plasma display panels (PDPs), as well as computers, smartphones, mobile phones, and other consumer electronics. The primary function of an MLCC is to store electrical energy by charging and to release it by discharging, thereby stabilizing voltage and filtering noise within the circuit.

MLCCs are often selected for electronic devices due to their numerous advantages, including compact size, high capacitance per unit volume, excellent reliability, and ease of surface mounting. As electronic devices such as computers, smartphones, and other portable equipment continue to become smaller, lighter, and more powerful, the demand for MLCCs with higher capacitance and further miniaturization has significantly increased. This trend has driven continuous innovation in MLCC design, materials, and manufacturing processes to meet the stringent requirements of next-generation electronic systems.

As the operating environments for multilayer ceramic capacitors (MLCCs) have become increasingly demanding—due to factors such as higher component density, thinner circuit boards, and exposure to mechanical stress—MLCCs are more susceptible to cracking. Such cracks often result from vibrations, bending, or mechanical deformation of the printed circuit board during assembly, transportation, or use. These cracks can compromise electrical performance, leading to short circuits or open circuits, and ultimately reduce the reliability of the electronic device. Accordingly, there is a need for MLCCs with enhanced mechanical robustness, particularly improved bending strength, to withstand these harsh conditions.

To address this issue, there have been efforts directed toward improving bending strength by modifying the structure of the MLCC, such as incorporating plate-shaped ceramic grains in the cover layers. This approach attempts to enhance crack resistance by increasing the propagation path of cracks, thereby slowing their growth when subjected to mechanical stress. However, this proposal introduces a new challenge: the interfacial bonding between the capacitance formation portion (active layer) and the cover layers may be weakened. Poor interfacial adhesion can lead to delamination or interfacial cracking, which negatively impacts both mechanical integrity and electrical reliability. Therefore, there remains a need for an MLCC structure that achieves high bending strength without sacrificing interfacial bonding strength.

### SUMMARY

The present disclosure relates to a multilayer electronic component.

An aspect of the present disclosure is to provide a multilayer electronic component with improved reliability.

Another aspect of the present disclosure is to provide a multilayer electronic component with improved bending strength.

Another aspect of the present disclosure is to provide a multilayer electronic component in which delamination or cracking at an interface between a cover portion and a capacitance formation portion is suppressed.

However, the objects of the present disclosure are not limited to the above-described contents and will be more readily understood when specific embodiments of the present disclosure are described.

According to an aspect of the present disclosure, a multilayer electronic component includes: a body including a capacitance formation portion including a dielectric layer and internal electrodes alternately arranged with the dielectric layer in a first direction and cover portions including dielectric grains and arranged on upper and lower surfaces of the capacitance formation portion in the first direction; and external electrodes arranged on both surfaces of the body in a second direction, perpendicular to the first direction, wherein the cover portion includes an inner cover portion adjacent to the capacitance formation portion and an outer cover portion adjacent to an outer side of the cover portion in the first direction, and LSi<LSo, in which, in a cross-section of the body in the first and second directions, LSo is a value obtained by dividing a sum of major axis lengths of dielectric grains included in the outer cover portion by a sum of minor axis lengths of the dielectric grains included in the outer cover portion and LSi is a value obtained by dividing a sum of major axis lengths of dielectric grains included in the inner cover portion by a sum of minor axis lengths of the dielectric grains included in the inner cover portion, and the outer cover portion includes a first dielectric grain in which a ratio of the major axis length to the minor axis length is 3 or greater and 30 or less.

### BRIEF DESCRIPTION OF DRAWINGS

The other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an exploded view of a body of FIG. 1;

FIG. 5 illustrates a first dielectric grain;

FIG. 6 illustrates a second dielectric grain;

FIG. 7 illustrates a region in which a plurality of first dielectric grains and a plurality of second dielectric grains are mixed;

FIG. 8 illustrates a region including a plurality of second dielectric grains;

FIG. 9 is a captured image of spherical powder particles;

FIG. 10 is a captured image of plate-shaped powder particles;

FIG. 11 is a perspective view of a second sheet;

FIG. 12 is a captured image of a cross-section taken along line III-III′ of FIG. 11; and

FIG. 13 is a graph illustrating the x-y shrinkage and z shrinkage of first and second sheets.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X-direction may be defined as a first direction, stacking direction, or thickness (T) direction, the Y-direction may be defined as a second direction or length (L) direction, and the Z-direction may be defined as a third direction or width (W) direction.

### Multilayer Electronic Component

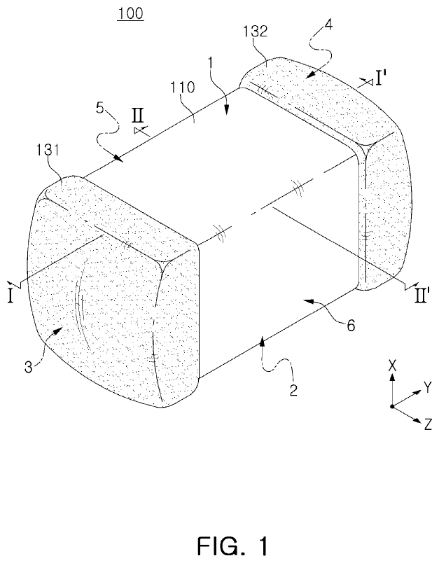

FIG. 1 is a perspective view schematically illustrating a multilayer electronic component according to an embodiment of the present disclosure.

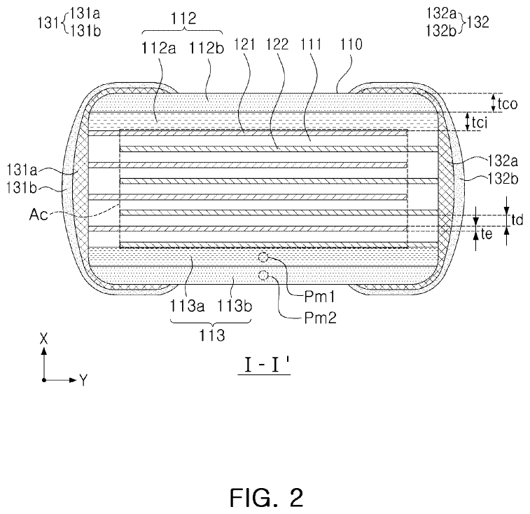

FIG. 2 is a cross-sectional view taken along line I-I′ of FIG. 1.

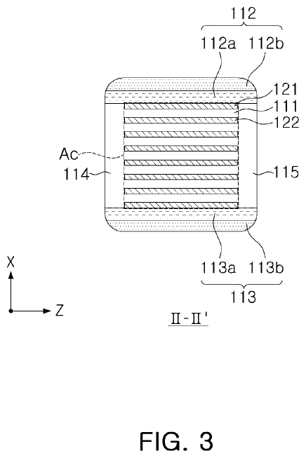

FIG. 3 is a cross-sectional view taken along line II-II′ of FIG. 1.

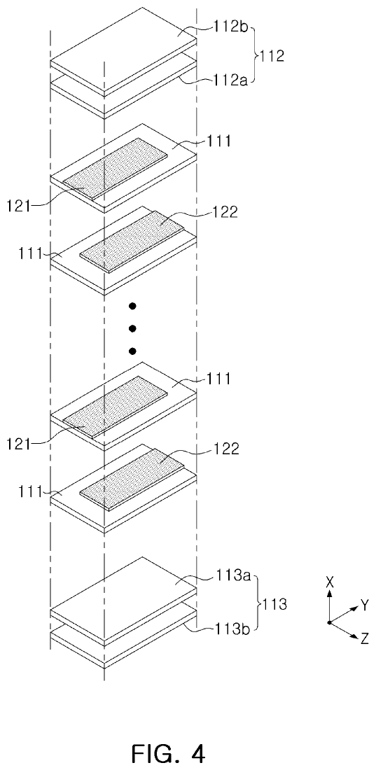

FIG. 4 is an exploded view of a body of FIG. 1.

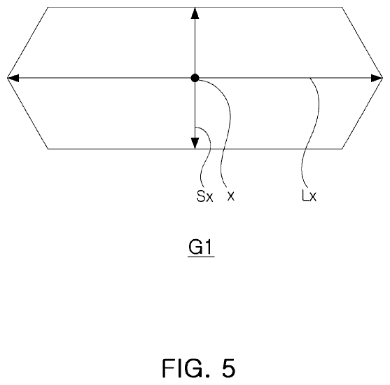

FIG. 5 illustrates a first dielectric grain.

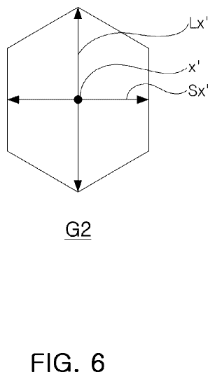

FIG. 6 illustrates a second dielectric grain.

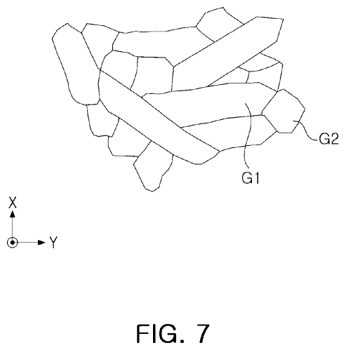

FIG. 7 illustrates a region in which a plurality of first dielectric grains and a plurality of second dielectric grains are mixed.

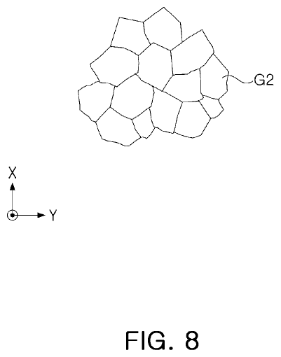

FIG. 8 illustrates a region including a plurality of second dielectric grains.

Hereinafter, a multilayer electronic component 100 according to an embodiment of the present disclosure will be described in detail with reference to FIG. 1, FIG. 2, FIG. 3, FIG. 4, FIG. 5, FIG. 6, FIG. 7 and FIG. 8 . . . . Furthermore, while a multilayer ceramic capacitor (MLCC) is described as an example of a multilayer electronic component, the present disclosure is not limited thereto and may be applied to various multilayer electronic components using ceramic materials, such as inductors, piezoelectric devices, varistors, or thermistors.

The multilayer electronic component 100 according to an embodiment of the present disclosure may include a body 110 including a capacitance formation portion Ac including a dielectric layer 111 and internal electrodes 121 and 122 alternately arranged with the dielectric layer in the first direction and cover portions 112 and 113 including dielectric grains G1 and G2 and arranged on upper and lower surfaces of the capacitance formation portion in the first direction; and external electrodes 131 and 132 arranged on both surfaces of the body in the second direction, perpendicular to the first direction, in which the cover portions include inner cover portions 112a and 113a adjacent to the capacitance formation portion and outer cover portions 112b and 113b adjacent to the outer side of the cover portion in the first direction, wherein, in a cross-section of the body in the first and second directions, when a value obtained by dividing the sum of the major axis lengths of the dielectric grains included in the outer cover portions 112b and 113b by the sum of the minor axis lengths of the dielectric grains included in the outer cover portions 112b and 113b is LSo and a value obtained by dividing the sum of the major axis lengths of the dielectric grains included in the inner cover portions 112a and 113a by the sum of the minor axis lengths of the dielectric grains included in the inner cover portions 112a and 113a is LSi, LSi<LSo is satisfied, and the outer cover portions 112b and 113b may include a first dielectric grain G1 in which a ratio (Lx/Sx) of the major axis length Lx to the minor axis length Sx is 3 or greater and 30 or less.

As the usage environment for MLCCs has become increasingly harsh, cracks may easily occur in MLCCs due to vibration or mechanical deformation of mounting boards, there is demand for the development of MLCCs with improved bending strength.

Thus, research has been conducted to improve bending strength by incorporating plate-shaped grains throughout a cover portion, as described in Patent Document 1. In this case, crack resistance may be improved by increasing a propagation path of cracks caused by vibrations or mechanical deformation of a mounting board. However, there is concern that interfacial bonding between a capacitance formation portion and the cover portion may be reduced, potentially leading to delamination or interfacial cracking.

However, according to an embodiment of the present disclosure, when a value obtained by dividing the sum of the major axis lengths of the dielectric grains included in the outer cover portions 112b and 113b by the sum of the minor axis lengths is LSo and a value obtained by dividing the sum of the major axis lengths of the dielectric grains included in the inner cover portions 112a and 113a by the sum of the minor axis lengths is LSi, LSi<LSo is satisfied, and the outer cover portions 112b and 113b includes the first dielectric grain G1 in which the ratio (Lx/Sx) of the major axis length Lx to the minor axis length Sx is 3 or greater and 30 or less, thereby enhancing the interfacial bonding between the capacitance formation portion and the cover portion, while enhancing bending strength, and thus, delamination and interfacial cracking may be suppressed.

Hereinafter, each component included in the multilayer electronic component 100 according to an embodiment of the present disclosure will be described.

The body 110 may include dielectric layers 111 and internal electrodes 121 and 122 that are alternately stacked.

While there are no specific limitations on the specific shape of the body 110, as illustrated, the body 110 may be formed to have a hexahedral shape or a similar shape. Due to shrinkage of ceramic powder particles included in the body 110 during a sintering process, the body 110 may not be a perfectly straight hexahedral shape, but may have a substantially hexahedral shape.

The body 110 may have first and second surfaces 1 and 2 facing in the first direction, third and fourth surfaces 3 and 4 connected to the first and second surfaces 1 and 2 and facing in the second direction, and fifth and sixth surfaces 5 and 6 connected to the first and second surfaces 1 and 2 and the third and fourth surfaces 3 and 4 and facing in the third direction.

As margin regions in which the internal electrodes 121 and 122 are not arranged overlap on the dielectric layer 111, a step difference may be created due to the thickness of the internal electrodes 121 and 122, and thus, the corners connecting the first surface and the third to fifth surfaces and/or the corners connecting the second surface and the third to fifth surfaces may have a shape contracted toward the center of the body 110 in the first direction when viewed based on the first or second surface. Alternatively, due to shrinkage behavior during the sintering process of the body, the corners connecting the first surface 1 to the third to sixth surfaces 3, 4, 5, and 6 and/or the corners connecting the second surface 2 to the third to sixth surfaces 3, 4, 5, and 6 may have a shape contracted toward the center of the body 110 in the first direction when viewed based on the first surface or the second surface. Alternatively, in order to prevent chipping defects, etc., a separate process may be performed to round the corners connecting each surface of the body 110, so that the corners connecting the first surface to the third to sixth surfaces and/or the corners connecting the second surface to the third to sixth surfaces may have a round shape.

Meanwhile, to suppress a step difference caused by the internal electrodes 121 and 122, after stacking, the internal electrodes may be cut to be exposed to the fifth and sixth surfaces 5 and 6 of the body and a single dielectric layer or two or more dielectric layers may be stacked on both sides of a capacitance formation portion Ac in the third direction (the width direction) to form the side margin portions 114 and 115. In this case, the portions connecting the first surface to the fifth and sixth surfaces and the portions connecting the second surface to the fifth and sixth surfaces may not have a contracted shape.

The plurality of dielectric layers 111 constituting the body 110 are in a sintered state, and adjacent dielectric layers 111 may be integrated such that boundaries therebetween may not be readily apparent without using a scanning electron microscope (SEM). The number of stacked dielectric layers is not particularly limited and may be determined based on the size of the multilayer electronic component. For example, the body may be formed by stacking 400 or more dielectric layers.

The dielectric layer 111 may be formed by preparing a ceramic slurry including ceramic powder, an organic solvent, and a binder, applying the slurry onto a carrier film and drying the slurry to form a ceramic green sheet, and then sintering the ceramic green sheet. The ceramic powder is not particularly limited as long as it may achieve sufficient capacitance. For example, barium titanate (BaTiO₃)-based powder may be used. For more specific examples, the ceramic powder may be barium titanate (BaTiO₃) powder, CaZrO₃-based paraelectric powder, etc. For more specific examples, the barium titanate (BaTiO₃)-based powder may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1), and the CaZrO₃-based paraelectric powder may be (Ca₁₋ₓSrₓ) (Zr_{1-y}Ti_{y})O₃ (0<x<1, 0<y<1).

Accordingly, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or (Ca₁₋ₓSrₓ) (Zr_{1-y}Ti_{y})O₃ (0<x<1, 0<y<1). In an embodiment, the dielectric layer 111 may include (Ca₁₋ₓSrₓ) (Zr_{1-y}Ti_{y})O₃ (0<x<1, 0<y<1) as a main component.

The body 110 may include the capacitance formation portion Ac formed within the body 110 and including the first internal electrode 121 and the second internal electrode 122 disposed to face each other with the dielectric layer 111 interposed therebetween to form capacitance and cover portions 112 and 113 formed on upper and lower surfaces of the capacitance formation portion Ac in the first direction.

Furthermore, the capacitance formation portion Ac contributes to the capacitance formation of the capacitor and may be formed by repeatedly stacking a plurality of first and second internal electrodes 121 and 122 with the dielectric layer 111 interposed therebetween.

The cover portions 112 and 113 may include the dielectric grains G1 and G2 and may be disposed above and below the capacitance formation portion Ac in the first direction.

Also, when the value obtained by dividing the sum of the major axis lengths of the dielectric grains included in the outer cover portions 112b and 113b in a cross-section of the body in the first and second directions (L-T cross-section) by the sum of the minor axis lengths is LSo and the value obtained by dividing the sum of the major axis lengths of the dielectric grains included in the inner cover portions 112a and 113a by the sum of the minor axis lengths is LSi, LSi<LSo may be satisfied, and the outer cover portions 112b and 113b may include the first dielectric grain G1 in which a ratio (Lx/Sx) of the major axis length Lx to the minor axis length Sx is 3 or greater and 30 or less.

Since the outer cover portions 112b and 113b include the first dielectric grains G1, a crack propagation path may be increased, thereby improving the bending strength. However, this does not mean that the outer cover portions 112b and 113b include only the first dielectric grains G1, and the outer cover portions 112b and 113b may include other dielectric grains in addition to the first dielectric grains G1.

Furthermore, by satisfying LSi<LSo, the bending strength may be improved while the interfacial bonding between the capacitance formation portion and the cover portions may be enhanced, thereby suppressing delamination and interfacial cracking.

The first dielectric grains G1 may have the ratio (Lx/Sx) of the major axis length Lx to the minor axis length Sx of 3 or greater and 30 or less.

If Lx/Sx is less than 3, the effect of increasing the crack propagation path may be insufficient. If Lx/Sx exceeds 30, a shrinkage difference may become excessively large, increasing the probability of interfacial cracking.

FIG. 5 illustrates the first dielectric grain G1. Referring to FIG. 5, the straight line having a maximum length within the first dielectric grain G1, while passing through the center x of the first dielectric grain G1 may be designated as the major axis of the first dielectric grain G1, and the length of the major axis may be designated as Lx. Also, the straight line, perpendicular to the major axis from the center x of the first dielectric grain G1, may be designated as the minor axis of the first dielectric grain G1, and the length of the minor axis may be designated as Sx. Here, the center x of the first dielectric grain G1 may refer to the center of gravity of the first dielectric grain G1 observed in the cross-section in the first and second directions.

The ratio (Lx/Sx) of the major axis length to the minor axis length of the first dielectric grain G1 may be measured from an image obtained by polishing the multilayer electronic component 100 to the center of the body 110 in the third direction to expose the cross-section in the first and second directions (L-T cross-section) and observing the exposed cross-section using a scanning electron microscope (SEM) or an optical microscope.

In an embodiment, the direction of the major axis length of the first dielectric grain G1 may be closer to the second direction than to the first direction. Accordingly, even if a crack occurs due to external stress, the crack may be prevented from propagating to the capacitance formation portion, thereby further improving the bending strength.

FIG. 7 illustrates a region in which a plurality of first dielectric grains G1 and a plurality of second grains G2 are mixed. It can be seen that the direction of the major axis length of the first dielectric grain G1 may is closer to the second direction than to the first direction, and the outer cover portions 112b and 113b may include dielectric grains of the form illustrated in FIG. 7. Referring to FIG. 2, region Pm2 in the L-T cross-section taken from the widthwise center of the multilayer electronic component may include dielectric grains of the form illustrated in FIG. 7.

FIG. 8 illustrates a region including a plurality of second dielectric grains G2. The inner cover portions 112a and 113a may include dielectric grains of the form illustrated in FIG. 8. Referring to FIG. 2, region Pm1 in the L-T cross-section taken from the widthwise center of the multilayer electronic component may include dielectric grains of the form illustrated in FIG. 8.

The cover portions 112 and 113 may include an upper cover portion 112 disposed above the capacitance formation portion Ac in the first direction and a lower cover portion 113 disposed below the capacitance formation portion Ac in the first direction.

In an embodiment, in the upper cover portion 112 and the lower cover portion 113, the outer cover portions 112b and 113b may each have an average thickness tco of 80 μm or more and 200 μm or less. Accordingly, the bending strength enhancement effect and the interfacial crack suppression effect of the present disclosure may be further enhanced.

If the average thickness tco of the outer cover portions 112b and 113b is less than 80 μm, the bending strength enhancement effect may be insufficient. If the average thickness tco of the outer cover portions 112b and 113b exceeds 200 μm, the delamination and interfacial crack suppression effect may be insufficient.

In an embodiment, in the upper cover portion 112 and the lower cover portion 113, the inner cover portions 112a and 113a may each have an average thickness tci of 100 μm or greater. Accordingly, the delamination and interfacial crack suppression effects of the present disclosure may be further enhanced.

If the average thickness tci of the inner cover portions 112a and 113a is less than 100 μm, the delamination and interfacial crack suppression effects may be insufficient.

There is no particular upper limit to the average thickness tci of the inner cover portions 112a and 113a. For example, tci may be 220 μm or less.

The average thickness tco of the outer cover portions 112b and 113b and the average thickness tci of the inner cover portions 112a and 113a may refer to the size thereof in the first direction and may be a value obtained by averaging sizes of the outer cover portions 112b and 113b and the inner cover portions 112a and 113a, respectively, measured at five equally spaced points above or below the capacitance formation portion Ac.

In an embodiment, when the number of dielectric grains included in the outer cover portions 112b and 113b is Nm0 and the number of first dielectric grains G1 is Nm1, Nm1/Nm0 may be 0.09 or greater. Accordingly, the crack propagation path may be further increased, thereby further improving the bending strength. More preferably, Nm1/Nm0 may be 0.11 or greater.

Meanwhile, an upper limit of Nm1/Nm0 may not be particularly limited, but it is preferably 0.65 or less. If Nm1/Nm0 exceeds 0.65, resulting in an excessive number of first dielectric grains G1, dense sintering may not be achieved due to insufficient sintering driving force due to a decrease in specific surface area. More preferably, Nm1/Nm0 may be 0.55 or less, and even more preferably, 0.45 or less.

The number of dielectric grains Nm0 and the number of first dielectric grains Nm1 included in the outer cover portions 112b and 113b may be measured from an image obtained by polishing the multilayer electronic component 100 to the center of the body 110 in the third direction to expose a cross-section (L-T cross-section) in the first and second directions and observing a region corresponding to the center of the outer cover portions 112b and 113b in the first direction in the exposed cross-section using a scanning electron microscope (SEM) at 3000× or greater.

While there is no specific need to limit the observation region, considering dispersion and measurement time, it may be desirable to observe a region of 50 μm×50 μm or more and 300 μm×300 μm or less. Furthermore, Nm0 and Nm1 may be further generalized by obtaining the values of Nm0 and Nm1 from a cross-section (L-T cross-section) obtained by cutting the body 110 in the first and second directions at five equally spaced points in the third direction, and then averaging these values as Nm0 and Nm1.

The minor axis length Sx and major axis length Lx of the first dielectric grain G1 may not be particularly limited. However, although the influence of the shape of the dielectric grain on shrinkage may be smaller, the size of the dielectric grain may also influence shrinkage. Therefore, the minor axis length Sx of the first dielectric grain is preferably 100 nm or more and 500 nm or less, and the major axis length Lx is preferably 300 nm or more and 5,000 nm or less.

Therefore, in an embodiment, the minor axis length Sx of the first dielectric grains may be 100 nm or more and 500 nm or less, and the major axis length Lx may be 300 nm or more and 5,000 nm or less.

In an embodiment, LSo may be 1.15 or greater. Accordingly, the crack propagation path may be increased, thereby further improving the bending strength.

In an embodiment, LSo may be 1.2 or more and 2.7 or less, and LSi may be less than 1.15. Accordingly, the crack propagation path, may be further increased thereby further improving the bending strength and enhancing the delamination and interfacial crack suppression effects.

In an embodiment, the inner cover portions 112a and 113a may include second dielectric grains G2 having a ratio (Lx′/Sx′) of the major axis length Lx′ to the minor axis length Sx′ of 1.5 or less. In the case of forming a dielectric layer using general spherical powder particles, most dielectric grains may have the same shape as the second dielectric grain G2. In addition, a lower limit of Lx′/Sx′ is 1.0, meaning that a case in which the minor axis and major axis lengths are equal corresponds to the second dielectric grain G2.

FIG. 6 illustrates the grain G2. Referring to FIG. 6, the straight line passing through the center x′ of the second dielectric grain G2 and having the maximum length within the second dielectric grain G2 may be designated as the major axis of the second dielectric grain G2, and the length of the major axis may be designated as Lx′. Also, the straight line, perpendicular to the major axis from the center x′ of the second dielectric grain G2, may be designated as the minor axis of the second dielectric grain G2, and the length of the minor axis may be designated as Sx′. Here, the center x′ of the second dielectric grain G2 may refer to the center of gravity of the second dielectric grain G2 observed in the cross-section in the first and second directions.

Meanwhile, the minor axis length Sx′ and major axis length Lx′ of the second dielectric grain G2 may not be particularly limited. For example, the minor axis length Sx′ of the second dielectric grain G2 may be 100 nm or more and 500 nm or less, and the major axis length Lx′ may be 100 nm or more and 500 nm or less.

In an embodiment, when a value obtained by dividing the sum of the major axis lengths of the dielectric grains included in the dielectric layer 111 by the sum of the minor axis lengths is Lsd, Lsd may be less than 1.15. This is because, when the dielectric layer 111 is formed using the general spherical powder particles, most of the dielectric grains may have the same shape as the second dielectric grain G2. That is, the dielectric layer 111 may include dielectric grains as illustrated in FIG. 8.

In an embodiment, the inner cover portions 112a and 113a may not include the first dielectric grains G1. Accordingly, the delamination and interfacial crack suppression effects may be further improved. That is, the inner cover portions 112a and 113a may be formed using a ceramic green sheet formed using general spherical powder particles.

In an embodiment, the outer cover portions 112b and 113b and the inner cover portions 112a and 113a may include the second dielectric grain G2 having a major-to-minor-length ratio of 1.5 or less, and the inner cover portion may not include the first dielectric grains G1.

The method for forming the cover portions 112 and 113 is not particularly limited.

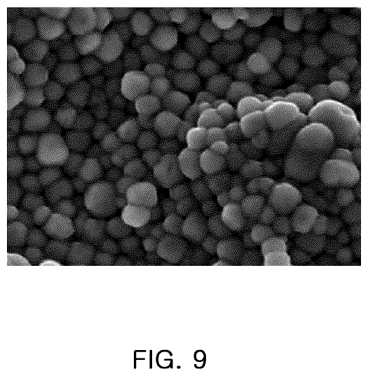

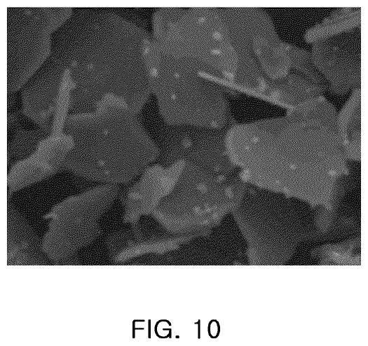

For example, the inner cover portions 112a and 113a may be formed by stacking a first sheet, which is a ceramic green sheet formed using the general spherical powder particles illustrated in FIG. 9, on the upper and lower surfaces of the capacitance formation portion Ac in the thickness direction, respectively. The outer cover portions 112b and 113b may be formed by stacking a second sheet, which is a ceramic green sheet formed by mixing the spherical powder particles illustrated in FIG. 9 and the plate-shaped powder particles illustrated in FIG. 10.

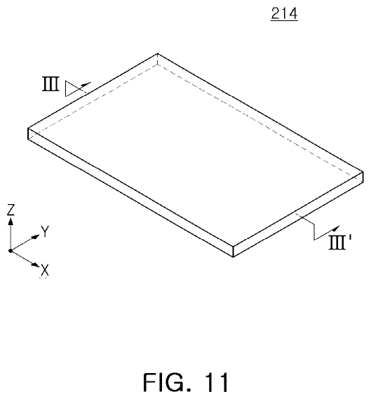

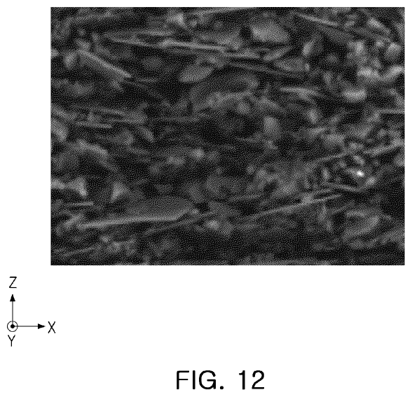

FIG. 11 is a perspective view of a second sheet 214, and FIG. 12 is a captured image of a cross-section taken along line III-III′ of FIG. 11. The second sheet 214 may be manufactured by using the spherical powder particles and the plate-shaped powder particles as raw materials, adding a binder and an organic solvent, such as ethanol, wet-mixing the mixture to prepare a slurry, applying the slurry on a carrier film through a narrow slit, and then drying the same.

Referring to FIG. 11 and FIG. 12, the second sheet has a thin plate shape, a thickness direction of the plate may be the Z-direction and length and width directions of the plate may be in the xy-direction. The plate-shaped powder particles may be aligned in the xy-direction of the second sheet when passing through the narrow slot and applied onto the carrier film.

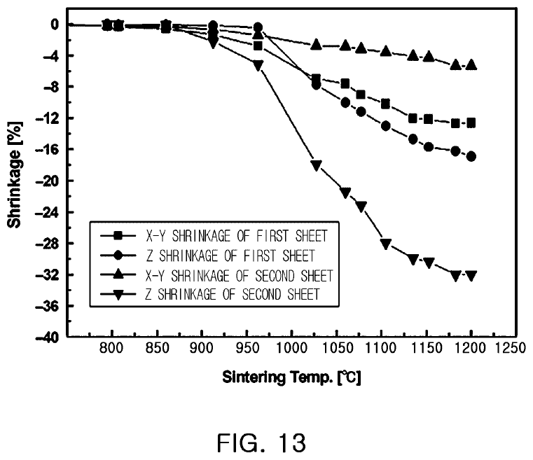

FIG. 13 is a graph illustrating the xy shrinkage and z shrinkage of the first and second sheets. Here, the first sheet is a ceramic green sheet including spherical powder particles but not plate-shaped powder particles, and the second sheet is a ceramic green sheet in which the weight ratio of the plate-shaped powder particles to the total weight of the spherical and plate-shaped powder particles is 0.3. In addition, the first sheet was manufactured to have the same shape as that of the second sheet 214 of FIG. 11. In the case of volume shrinkage, the first sheet and the second sheet have similar values, but when the xy shrinkage and z shrinkage are measured separately as in FIG. 13, it can be seen that the xy shrinkage of the second sheet is significantly lower than that of the first sheet, and the z shrinkage of the second sheet is significantly higher than that of the first sheet. Therefore, it can be seen that, when the ceramic green sheet includes plate-like powder particles, the xy-direction shrinkage is suppressed and the z-direction shrinkage increases during sintering. Therefore, when the cover portion is formed using only the second sheet, stress may occur at the interface with the capacitance formation portion due to the difference in shrinkage, and if the generated stress exceeds interlayer bonding force, an interfacial crack may occur. According to an embodiment of the present disclosure, the cover portions 112 and 113 may include the inner cover portions 112a and 113a and the outer cover portions 112b and 113b, and since the aforementioned LSi<LSo is satisfied, bending strength may be improved, while the interfacial bonding between the capacitance formation portion and the cover portions may be enhanced, thereby suppressing delamination and interfacial cracking.

Meanwhile, the spherical powder particle and the plate-shaped powder particle may be the same type of ceramic material but are not limited thereto.

The cover portions 112 and 113 may not include internal electrodes and may include the same material as that of the dielectric layer 111. For example, the cover portions 112 and 113 may include, as main components, one or more of BaTiO₃, (Ba₁₋ₓCaₓ)TiO₃ (0<x<1), Ba(Ti_{1-y}Ca_{y})O3 (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), or (Ca₁₋ₓSrₓ) (Zr_{1-y}Ti_{y})O₃ (0<x<1, 0<y<1).

In addition, the margin portions 114 and 115 may be arranged on the side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in the width direction.

The margin portions 114 and 115 may refer to a region between both ends of the first and second internal electrodes 121 and 122 and the boundary of the body 110 in a cross-section of the body 110 taken in the width-thickness (W-T) direction.

The margin portions 114 and 115 may fundamentally serve to prevent damage to the internal electrodes due to physical or chemical stress.

The margin portions 114 and 115 may be formed by applying conductive paste to the ceramic green sheet, excluding the region in which the margins will be formed, to form the internal electrodes.

In addition, to suppress a step difference caused by the internal electrodes 121 and 122, after stacking, the internal electrodes may be cut to be exposed to the fifth and sixth surfaces 5 and 6 of the body, and then, a single dielectric layer or two or more dielectric layers may be stacked on both sides of the capacitance formation portion Ac in the third direction (width direction) to form the margin portions 114 and 115.

Meanwhile, the width of the margin portions 114 and 115 may not be particularly limited. However, to facilitate miniaturization and high capacitance of multilayer electronic components, the average width of the margin portions 114 and 115 may be 15 μm or less.

The average width of the margin portions 114 and 115 may refer to the average size MW1 of the region in which the internal electrode is spaced apart from the fifth surface in the third direction and the average size MW2 of the region in which the internal electrode is spaced apart from the sixth surface in the third direction and may be the average value of the sizes of the margin portions 114 and 115 measured at five equally spaced points on the side surface of the capacitance formation portion Ac in the third direction.

Therefore, in an embodiment, the average sizes MW1 and MW2 of the regions in which the internal electrodes 121 and 122 are spaced apart from the fifth and sixth surfaces in the third direction may each be 15 μm or less.

The internal electrodes 121 and 122 may include first and second internal electrodes 121 and 122. The first and second internal electrodes 121 and 122 are alternately arranged to face each other with the dielectric layer 111 forming the body 110 interposed therebetween and may be exposed through the third and fourth surfaces 3 and 4 of the body 110, respectively.

The first internal electrode 121 may be spaced apart from the fourth surface 4 and exposed through the third surface 3, while the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may be connected to the first external electrode 131 and not to the second external electrode 132, and the second internal electrode 122 may be connected to the second external electrode 132 and not to the first external electrode 131. Therefore, the first internal electrode 121 may be formed at a predetermined distance from the fourth surface 4, and the second internal electrode 122 may be formed at a predetermined distance from the third surface 3. In addition, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, W, Ti, or alloys thereof, but the present disclosure is not limited thereto.

An average thickness td of the dielectric layer 111 may not be particularly limited, but may be, for example, 0.1 μm to 10 μm. An average thickness the of the internal electrodes 121 and 122 may not be particularly limited, but may be, for example, 0.05 μm to 3.0 μm. In addition, the average thickness td of the dielectric layer 111 and the average thickness the of the internal electrodes 121 and 122 may be arbitrarily set according to the desired characteristics or purpose. For example, to achieve miniaturization and high capacitance, in the case of electronic components for high-voltage electric devices, the average thickness td of the dielectric layer 111 may be less than 2.8 μm, and the average thickness the of the internal electrodes 121 and 122 may be less than 1 μm. In addition, to achieve miniaturization and high capacitance, in the case of small IT electronic components, the average thickness td of the dielectric layer 111 may be 0.4 μm or less, and the average thickness the of the internal electrodes 121 and 122 may be 0.4 μm or less.

An average thickness td of the dielectric layer 111 and the average thickness the of the internal electrodes 121 and 122 refer to the sizes of the dielectric layer 111 and the internal electrodes 121 and 122, respectively, in the first direction. The average thickness td of the dielectric layer 111 and the average thickness the of the internal electrodes 121 and 122 may be measured by scanning a cross-section of the body 110 in the first and second directions using a scanning electron microscope (SEM) at 10,000× magnification. More specifically, the average thickness td of the dielectric layer 111 may be obtained by measuring the thicknesses at a plurality of points on one dielectric layer 111, for example, 30 equally spaced points in the second direction, and then calculating an average value. Furthermore, the average thickness the of the internal electrodes 121 and 122 may be obtained by measuring the thicknesses at a plurality of points on one internal electrode 121 or 122, for example, 30 equally spaced points in the second direction, and then calculating an average value. The 30 equally spaced points may be designated in the capacitance formation portion Ac. Meanwhile, by performing the average value measurement on ten dielectric layers 111 and ten internal electrodes 121 and 122 and then calculating the average value, the average thickness td of the dielectric layer 111 and the average thickness the of the internal electrodes 121 and 122 may be further generalized.

The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include first and second external electrodes 131 and 132 connected to the first and second internal electrodes 121 and 122, respectively.

Referring to FIG. 1, the external electrodes 131 and 132 may be arranged to cover both end surfaces of the side margin portions 114 and 115 in the second direction.

In the present embodiment, a structure in which the multilayer electronic component 100 has two external electrodes 131 and 132 is described. However, the number and shape of the external electrodes 131 and 132 may vary depending on the shape of the internal electrodes 121 and 122 or other purposes.

Meanwhile, the external electrodes 131 and 132 may be formed using any material having electrical conductivity, such as metal. A specific material may be determined based on electrical characteristics, structural stability, and other factors.

Furthermore, the external electrodes may have a multilayer structure.

For example, the external electrodes 131 and 132 may include electrode layers 131a and 132a disposed on the body 110 and plating layers 131b and 132b formed on the electrode layers 131a and 132a.

More specifically, the electrode layers 131a and 132a may be sintered electrodes including a conductive metal and glass or resin-based electrodes including a conductive metal and resin.

Furthermore, the electrode layers 131a and 132a may be formed by sequentially forming sintered electrodes and resin-based electrodes on the body. Furthermore, the electrode layers 131a and 132a may be formed by transferring a sheet including a conductive metal onto the body or by transferring a sheet including a conductive metal onto a sintered electrode.

The conductive metal included in the electrode layers 131a and 132a may be any material with excellent electrical conductivity and is not particularly limited. For example, the conductive metal may be one or more of nickel (Ni), copper (Cu), or alloys thereof.

The plating layers 131b and 132b serve to improve mounting characteristics. The type of plating layers 131b and 132b is not particularly limited and may include one or more of nickel, tin, palladium, or alloys thereof, and may be formed as a plurality of layers.

More specifically, the plating layers 131b and 132b may be Ni or Sn plating layers. An Ni plating layer and an Sn plating layer may be sequentially formed on the electrode layers 131a and 132a, or an Sn plating layer, an Ni plating layer, and an Sn plating layer may be sequentially formed. In addition, the plating layers 131b and 132b may include a plurality of Ni plating layers and/or a plurality of Sn plating layers.

Meanwhile, when the external electrodes include a conductive resin layer to improve bending strength, there are concerns that ESR may increase and a joint may come off due to a high coefficient of thermal expansion of the resin and decomposition gases in environments, such as thermal shock.

According to the present disclosure, even if the external electrodes do not include a conductive resin layer, sufficient bending strength may be secured by controlling the configuration of the cover portions. Therefore, in an embodiment, the external electrodes 131 and 132 may include electrode layers 131a and 132a contacting the internal electrodes 121 and 122 and including glass and metal and plating layers 131b and 132b arranged to contact the electrode layers on the electrode layers.

The size of the multilayer electronic component 100 is not particularly limited. For example, the size of the multilayer electronic component 100 may be 0201 (length×width, 0.2 mm×0.1 mm), 0603 (length×width, 0.6 mm×0.3 mm), 1005 (length×width, 1.0 mm×0.5 mm), etc.

### Method of Manufacturing Multilayer Electronic Component

Hereinafter, an example of a method of manufacturing the multilayer electronic component 100 according to an embodiment of the present disclosure will be described. However, the method of manufacturing the multilayer electronic component 100 of the present disclosure is not limited thereto.

First, a ceramic slurry including spherical powder particles, an organic solvent, and a binder may be applied onto a carrier film to form a ceramic green sheet (a first sheet).

Furthermore, a ceramic slurry including spherical powder particles, plate-shaped powder particles, an organic solvent, and a binder may be applied onto a carrier film to form a ceramic green sheet (a second sheet).

Thereafter, a conductive paste for internal electrodes, including metal powder particles, a binder, and an organic solvent, may be printed onto the first sheet with a certain thickness using a screen printing or gravure printing method to form an internal electrode pattern, thereby manufacturing a ceramic green sheet for a capacitance formation portion.

A stack may be obtained by sequentially stacking one or more second sheets, one or more first sheets, two or more ceramic green sheets for capacitance formation portions, one or more first sheets, and one or more second sheets in the X-direction.

The first sheet stack portion forms the inner cover portion after sintering, the second sheet stack portion forms the outer cover portion after sintering, and the ceramic green sheet stack portion for capacitance formation portions may form the capacitance formation portion.

Accordingly, when a value obtained by dividing the sum of the major axis lengths of the dielectric grains included in the outer cover portions by the sum of the minor axis lengths is LSo and a value obtained by dividing the sum of the major axis lengths of the dielectric grains included in the inner cover portions by the sum of the minor axis lengths is LSi, LSi<LSo is satisfied, and the outer cover portions may include the first dielectric grain in which the ratio of the major axis length to the minor axis length is 3 or greater and 30 or less.

Thereafter, the stack may then be cut into a predetermined chip size to obtain a unit stack.

Thereafter, the unit stack may be sintered to obtain a body. The sintering temperature is not particularly limited and may range from 900° C. to 1400° C.

Thereafter, the external electrodes 131 and 132 are formed. For example, in a case in which the electrode layers 131a and 132a include a sintered electrode layer, the body 110 may be dipped in a conductive paste for external electrodes, including metal powder particles, glass frit, a binder, and an organic solvent, and then the conductive paste for external electrodes may be sintered at a temperature of 500° C. to 900° C. to form the sintered electrode layer.

In addition, the plating layers 131b and 132b may be formed on the electrode layers 131a and 132a by additionally performing electrolytic plating and/or electroless plating.

### EXPERIMENTAL EXAMPLE

Sample chips were manufactured using the above-described manufacturing method to satisfy the average thickness tco of the outer cover portion and the average thickness tci of the inner cover portion illustrated in Table 1 below. Here, the first sheet did not include plate-shaped powder particles, and the second sheet included 100 wt % of ceramic powder particles including 58 wt % of spherical powder particles and 42 wt % of plate-shaped powder particles.

For each test number, 20 sample chips were mounted on a PCB substrate, and the surface opposite to the mounting surface was pressed up to 6 mm. The percentage of sample chips that developed bending cracks and interfacial cracks (active/cover cracks) is illustrated in Table 1.

Cracks were determined by polishing each sample chip to the center in the width direction and observing an L-T cross-section. A case in which a crack propagated to the capacitance formation portion was determined that a bending crack occurred. A case in which a delamination or crack equal to or greater than 5 μm occurred at the interface between the capacitance formation portion and the cover portion was determined that an interfacial crack (active/cover crack) occurred.

TABLE 1

| Test | | | Bending crack | Active/cover crack |
|---|---|---|---|---|
| No. | tco(μm) | tci(μm) | incidence | incidence |
| 1 | 300 | 0 | 0.00% | 45.00% |
| 2 | 260 | 40 | 0.00% | 30.00% |
| 3 | 240 | 60 | 0.00% | 15.00% |
| 4 | 200 | 100 | 0.00% | 0.00% |
| 5 | 150 | 150 | 0.00% | 0.00% |
| 6 | 100 | 200 | 0.00% | 0.00% |
| 7 | 80 | 220 | 0.00% | 0.00% |
| 8 | 60 | 240 | 15.00% | 0.00% |
| 9 | 40 | 260 | 40.00% | 0.00% |
| 10 | 200 | 200 | 0.00% | 0.00% |
| 11 | 240 | 160 | 0.00% | 5.00% |
| 12 | 300 | 100 | 0.00% | 15.00% |

In Test No. 1, in which the cover portion was formed only with the second sheet, it can be seen that the interfacial crack incidence was high at 45%. Meanwhile, In Test Nos. 2 to 12, in which the inner cover portion was formed with the first sheet and the outer cover portion was formed with the second sheet, it can be seen that the interfacial crack incidence was reduced by 15% or more.

Meanwhile, it can be seen that, Test Nos. 4 to 10, in which the tco was less than 240 μm, the interfacial crack incidence was excellent as 0%.

Furthermore, it can be seen that, when the tco exceeded 60 μm, the bending crack incidence was excellent as 0%.

Therefore, it can be seen that the tco is preferably greater than 60 μm and less than 240 μm, and more preferably greater than 80 μm and less than 200 μm.

As one of various effects of the present disclosure, the multilayer electronic component with improved bending strength may be provided.

As one of various effects of the present disclosure, the multilayer electronic component in which delamination or cracking at the interface between the cover portion and the capacitance formation portion is suppressed.

However, the various advantages and effects of the present disclosure are not limited to the above-described contents and will be more readily understood as specific embodiments of the present disclosure are described.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the embodiments. As used herein, the singular forms “a,” “an,” and “the” are intended to include the plural forms as well, unless the context clearly indicates otherwise.

What is claimed is:

1. A multilayer electronic component comprising:
a body including a capacitance formation portion including a dielectric layer and internal electrodes alternately arranged with the dielectric layer in a first direction and cover portions including dielectric grains and arranged on upper and lower surfaces of the capacitance formation portion in the first direction; and
external electrodes arranged on both surfaces of the body in a second direction, perpendicular to the first direction,
wherein the cover portion includes an inner cover portion adjacent to the capacitance formation portion and an outer cover portion adjacent to an outer side of the cover portion in the first direction, and
LSi<LSo, in which, in a cross-section of the body in the first and second directions, LSo is a value obtained by dividing a sum of major axis lengths of dielectric grains included in the outer cover portion by a sum of minor axis lengths of the dielectric grains included in the outer cover portion and LSi is a value obtained by dividing a sum of major axis lengths of dielectric grains included in the inner cover portion by a sum of minor axis lengths of the dielectric grains included in the inner cover portion, and
the outer cover portion includes a first dielectric grain in which a ratio of the major axis length to the minor axis length is 3 or greater and 30 or less.

2. The multilayer electronic component of claim 1, wherein
the cover portion includes an upper cover portion disposed on the upper surface of the capacitance formation portion in the first direction and a lower cover portion disposed on the lower surface of the capacitance formation portion in the first direction, and
the outer cover portion of each of the upper cover portion and the lower cover portion has an average thickness of 80 μm or greater and 200 μm or less.

3. The multilayer electronic component of claim 2, wherein the inner cover portion of each of the upper cover portion and the lower cover portion has an average thickness of 100 μm or greater.

4. The multilayer electronic component of claim 1, wherein Nm1/Nm0 is 0.09 or greater, in which Nm0 is a number of dielectric grains included in the outer cover portion and Nm1 is a number of first dielectric grains.

5. The multilayer electronic component of claim 1, wherein the minor axis length of the first dielectric grain is 100 nm or greater and 500 nm or less, and the major axis length is 300 nm or greater and 5000 nm or less.

6. The multilayer electronic component of claim 1, wherein the LSo is 1.15 or higher.

7. The multilayer electronic component of claim 1, wherein the LSo is 1.2 or greater and 2.7 or less, and the LSi is less than 1.15.

8. The multilayer electronic component of claim 1, wherein the inner cover portion includes a second dielectric grain in which a ratio of the major axis length to the minor axis length is 1.5 or less.

9. The multilayer electronic component of claim 8, wherein a minor axis length of the second dielectric grain is 100 nm or greater and 500 nm or less, and a major axis length of the second dielectric grain is 100 nm or greater and 500 nm or less.

10. The multilayer electronic component of claim 1, wherein the inner cover portion does not include the first dielectric grain.

11. The multilayer electronic component of claim 1, wherein
the outer cover portion and the inner cover portion include a second dielectric grain in which a ratio of a major axis length to a minor axis length is 1.5 or less, and
the inner cover portion does not include the first dielectric grain.

12. The multilayer electronic component of claim 1, wherein Lsd is less than 1.15, in which Lsd is a value obtained by dividing a sum of major axis lengths of dielectric grains included in the dielectric layer by a sum of minor axis lengths of the dielectric grains.

13. The multilayer electronic component of claim 1, wherein the external electrode includes an electrode layer in contact with the internal electrode and including glass and metal and a plating layer disposed to be in contact with the electrode layer on the electrode layer.

14. The multilayer electronic component of claim 1, wherein a direction of the major axis length of the first dielectric grain is closer to the second direction than to the first direction.

15. The multilayer electronic component of claim 1, wherein the external electrodes are free of a conductive resin layer.

16. A method of manufacturing a multilayer electronic component, comprising:
forming a first ceramic green sheet using spherical ceramic powder particles;
forming a second ceramic green sheet using a mixture of spherical ceramic powder particles and plate-shaped ceramic powder particles such that the plate-shaped particles are aligned substantially in-plane of the sheet;
printing a conductive paste pattern on ceramic green sheets for a capacitance formation portion to provide internal electrodes;
stacking, in a first direction, at least one of the second sheets as an outer cover portion, at least one of the first sheets as an inner cover portion, a plurality of said ceramic green sheets for the capacitance formation portion, at least one first sheet as an inner cover portion, and at least one second sheet as an outer cover portion;
cutting to obtain unit stacks and sintering to form a body; and
forming external electrodes on opposite sides of the body in a second direction perpendicular to the first direction;
whereby, in a cross-section in the first and second directions, LSi<LSo, and the outer cover portion includes first dielectric grains with a major-to-minor axis ratio of 3 to 30.

17. The method of claim 15, wherein the plate-shaped particles are aligned in the sheet plane by applying the slurry through a narrow slot onto a carrier film.

18. The method of claim 15, wherein the second sheet contains about 42 wt % plate-shaped and about 58 wt % spherical ceramic powder particles.

19. The method of claim 15, wherein sintering is conducted at 900° C. to 1400° C.

20. The method of claim 15, wherein the first dielectric grains in the outer cover portion have a minor axis of 100-500 nm and a major axis of 300-5000 nm.
